(19) United States
(12) Patent Application Publication
(10) Pub. No.: US 2004/0212127 A1
(43) Pub. Date: Oct. 28, 2004

(54) Method for producing weather strip for motor vehicle

(75) Inventors: Yoichi Saji, Aichi-ken (JP); Masahiko Ito, Aichi-ken (JP)

Correspondence Address: POSZ & BETHARDS, PLC, 11250 ROGER BACON DRIVE, SUITE 10, RESTON, VA, 20190, US

(73) Assignee: TOYODA GOSEI CO., LTD.

(21) Appl. No.: 10/829,256

(22) Filed: Apr. 22, 2004

(30) Foreign Application Priority Data
Apr. 28, 2003 (JP) 2003-123661

(51) Int. Cl. B29C 45/16

(52) U.S. Cl. 264/255

(57) ABSTRACT

A method for producing a weather strip having an extruded straight part and a molded part molded at an end of the extruded straight part, which enables smooth injection of a molding material, and does not require any additional cutting process, thereby exhibiting improved productivity. The method includes the steps of providing protrusions in a mold so as to protrude into a mold cavity from positions adapted to mold a bottom part of the weather strip, injecting a molding material into the mold cavity with a plurality of sprue gates which are provided on an upper side of the mold so as to extend downwardly through the protrusions, directly or by way of short gates, and opening the mold such that the molding material is cut at joints between the sprue gates and the mold cavity.

### CROSS-REFERENCE TO RELATED APPLICATION

This application is related to and claims priority from Japanese patent application No. 2003-123661, incorporated herein by reference.

### BACKGROUND OF THE INVENTION

1. Field of the Invention

The present invention relates to a method for producing a weather strip which includes an extruded straight part and a molded part provided at an end of the extruded straight part.

2. Description of Related Art

As shown in FIG. 1, a door glass run 10 as one example of a weather strip is attached to a door frame 12 of a vehicle door 14 for guiding and holding a door glass 16. The door glass run 10 has a configuration conforming to an inner periphery of the door frame 12. As shown in FIG. 2, the door glass run 10 includes straight parts 18 which are formed by extrusion, and a corner part 20 for attachment to a corner of the door frame 12 (FIG. 1). The corner part 20 is formed by molding.

To mold the corner part 20, as shown in FIG. 3, ends of the extruded straight parts 18 are placed in a mold 22 so as to face a mold cavity 24, and a molding material is injected into the mold cavity 24 to connect the extruded straight parts 18 with the molded corner part 20 (publication of unexamined Japanese patent application No. 2000-16089, pages 3 to 4, and FIG. 1, ex.).

Generally, the molded corner part 20 and the extruded straight parts 18 are composed of an identical material to each other. Where a rubber material is used, the molded corner part 20 is jointed to the ends of the extruded straight parts 18 when vulcanizing the rubber material. And where a thermoplastic material is used, the thermoplastic material injected into the mold cavity 24 in a molten state welds the ends of the extruded straight parts 18 to join the molded corner part 20 to the extruded straight parts 18.

As shown in FIG. 3, the mold 22 for molding the corner part 20 includes an upper mold 26, a lower mold 28, an inside middle mold 30 and an outside middle mold 32. The inside middle mold 30 and the outside middle mold 32 are interposed between the upper mold 26 and the lower mold 28, and a resultant mold is closed to define the mold cavity 24. A molding material is injected from an upper part of the upper mold 26 into the mold cavity 24 with both a plurality of first sprue gates 34 and a plurality of second sprue gates 36.

These sprue gates 34 and 36 extend in a generally vertical direction through the upper mold 26 and the outside middle mold 32, and open into the mold cavity 24. The molding material for composing an inside wall, an inside seal lip and an inside moulding lip of the door glass run 10 is injected with the first sprue gates 34, whereas the molding material for composing a bottom wall, an outside wall, an outside seal lip and an outside moulding lip is injected with the second sprue gates 36.

To inject the molding material into the mold cavity 24 with the second sprue gates 36, tab gates 38 are needed for connecting lower ends of the second sprue gates 36 with the mold cavity 24. The second sprue gates 36 are provided at a distance from the mold cavity 24 for facilitating the manufacturing of the mold, and accordingly, the tab gates 38 have a length equal to the distance between the second sprue gates 36 and the mold cavity 24 (publication of unexamined Japanese patent application No. 2001-300987, pages 3 to 4, and FIG. 1, ex.).

This arrangement, however, has the problem that long tabs 40 are formed in the molded corner part 20 due to the tab gates 38, and when the door glass run 10 is attached to the door frame 12, ends of the tabs 40, which project outwardly of the molded corner part 20, contact a bottom of the door frame 12 so that the door glass run 10 may not be attached to the door frame 12 closely.

Conventionally, the tabs 40 have been cut off at their roots with cutting means such as scissors, etc. This method, however, results in a waste of the molding material, and takes time and labor to cut off the tabs 40 precisely, thereby increasing both the production costs and production time.

### SUMMARY OF THE INVENTION

It is an object of the present invention to provide a method for producing a weather strip having an extruded straight part and a molded part formed at an end of the straight extruded part with good productivity, which enables a molding material to be injected into a mold smoothly, and does not require any additional process. The method of the present invention includes the steps of providing protrusions in a mold so as to protrude into a mold cavity from positions adapted to mold a bottom part of the weather strip, injecting a molding material from an upper face of the mold into the mold cavity from positions adapted to mold a side part of the weather strip with a plurality of first sprue gates provided on an upper side of the mold, injecting a molding material from an upper face of he mold into the mold cavity from positions adapted to mold the bottom part and another side part of the weather strip through the protrusions provided in the mold with a plurality of second sprue gates provided on the upper side of the mold, and opening the mold such that the molding material is cut at joints between the second sprue gates and the mold cavity.

In accordance with the present invention, since the molding material adapted to mold one side part of the weather strip is injected with the first sprue gates, whereas the molding material adapted to mold the bottom part and another side part of the weather strip is injected with the second sprue gates, the mold cavity can be entirely filled with the molding material speedily and uniformly. And, since the protrusions are provided in the mold so as to protrude into the mold cavity from the positions adapted to mold the bottom part of the weather strip, and the molding material is injected with the second sprue gates directly or by way of short tab gates provided in the protrusions, the molded part which is after the second sprue gates are cut off does not have any projection or long tab which projects from the bottom part of the weather strip. Accordingly, the weather strip can be attached to a vehicle securely and closely.

In addition, when the mold is opened, the second sprue gates are cut off at the joints with the mold cavity automatically, no cutting process with scissors, etc. is required after molding. Accordingly, the productivity of the weather strips is improved.

The method in accordance with the present invention is applicable to the production of a door glass run which includes extruded straight parts having a generally U-shaped cross-section, and a molded part molded for connecting ends of the extruded straight parts to each other. In this case, the protrusions are provided in the mold so as to protrude into the mold cavity from the positions adapted to mold a bottom wall of the door glass run, the plurality of first sprue gates are provided so as to open into the mold cavity from the positions adapted to mold a side wall of the U-shaped door glass run, and the plurality of second sprue gates are provided so as to extend through the protrusions, and open into the mold cavity from the positions adapted to mold a bottom wall and another side wall of the U-shaped door glass run, directly or by way of short tabs provided in the protrusions. With this method, since the molding material adapted to mold one side wall of the door glass run is injected with the first sprue gates, whereas the molding material adapted to mold the bottom wall and another side wall of the door glass run is injected with the second sprue gates, the mold cavity can be entirely filled with the molding material speedily and uniformly. And, since the protrusions are provided in the mold so as to protrude into the mold cavity from the positions adapted to mold the bottom wall of the door glass run, and the molding material is injected with the second sprue gates directly or by way of short tab gates provided in the protrusions, the molded part which is after the second sprue gates are cut off does not have any projection or long tab which projects from the bottom wall of the molded part. Resultant projections are located in resultant depressions formed in the bottom wall of the molded part so as not to contact a door frame when attached thereto, and accordingly, the door glass run can be attached to the door frame securely and closely.

In a preferred embodiment, the second sprue gates are provided in an oblique direction relative to the opening and closing direction of the mold, and open into the mold cavity directly, and lower ends of the second sprue gates, each having a reduced diameter, are located in the protrusions provided in the mold.

With this arrangement, the second sprue gate can be provided without interfering with an upper part of the mold cavity, and the lower ends of the second sprue gate open into a lower part of the mold cavity directly without providing any tab gate.

In another preferred embodiment, the protrusions are provided in the mold so as to protrude from the positions adapted to mold an upper side of the bottom wall of the door glass run, and the second sprue gates are provided so as to extend through the protrusions in a generally vertical direction, and open into a lower part of the mold cavity by way of short tab gates.

With this arrangement, by virtue of the protrusions, the second sprue gates can extend to the vicinity of the lower part of the mold cavity in a generally vertical direction without interfering with the upper part of the mold cavity. Accordingly, the molding material can be injected into the lower part of the mold cavity with the second sprue gates at the same time with the injection into the upper part of the mold cavity with the first sprue gates. In addition, no long tab gate is needed to connect the lower ends of the second sprue gates with the lower part of the mold cavity, and the length of each second sprue gate can be reduced, as compared with the obliquely extending sprue gates. Consequently, the molding material can be injected into the mold cavity speedily and smoothly.

Other objects, features, and characteristics of the present invention will become apparent upon consideration of the following description and the appended claims with reference to the accompanying drawings, all of which form a part of this specification.

### BRIEF DESCRIPTION OF THE DRAWINGS

FIG. 1 is a front view of a door of a motor vehicle.

FIG. 2 is a plan view of a corner part of a door glass run, which is produced with a conventional method;

FIG. 3 is a partially cut away cross-sectional view of a main part of a mold for molding the corner part of the door glass run, which has been used in the conventional method;

FIG. 4 is a cross-sectional view of a door glass run taken along the line A-A of FIG 1;

FIG. 5 is a plan view of a corner part of a door glass run, which is produced with an embodiment of a method in accordance with the present invention;

FIG. 6 is a partially cut away cross-sectional view of a main part of a mold for molding the corner part of the door glass run, which is used in one embodiment of the method in accordance with the present invention;

FIG. 7 is a partially cut away cross-sectional view of a main part of a mold for molding the corner part of the door glass run, of which an upper mold is opened; and

FIG. 8 is a partially cut away perspective view explaining the arrangement of the sprue gates which are used in another embodiment of the method in accordance with the present invention.

### DETAILED DESCRIPTION OF THE PREFERRED EMBODIMENTS

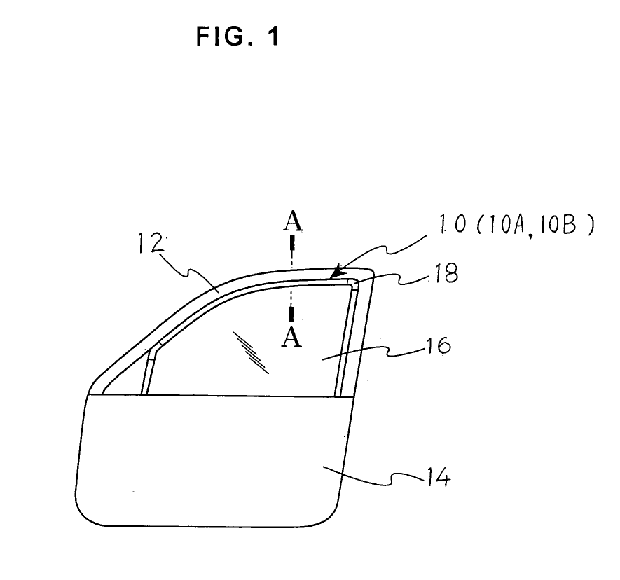

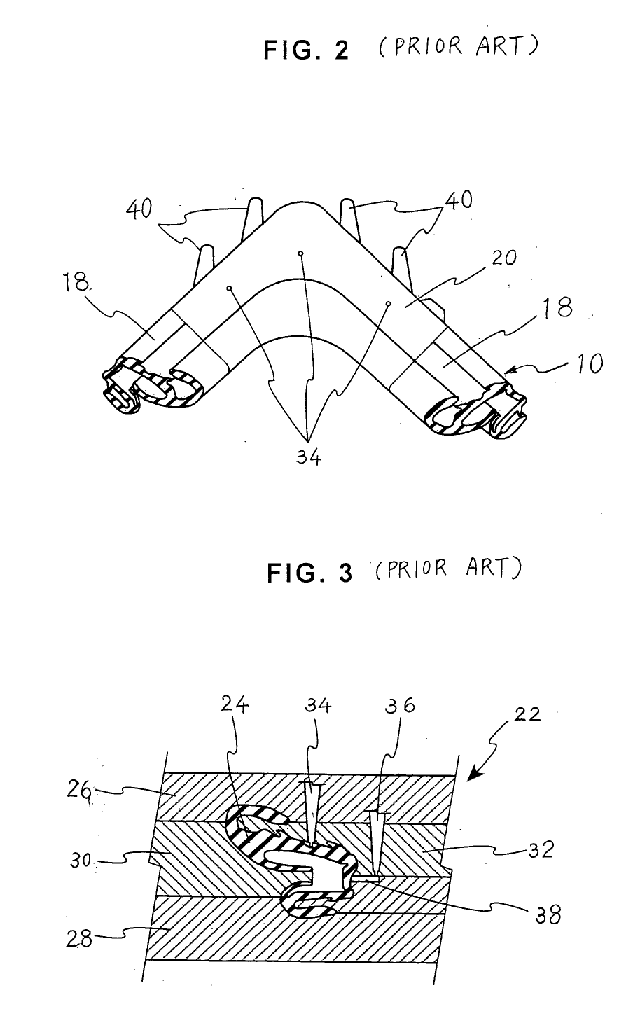

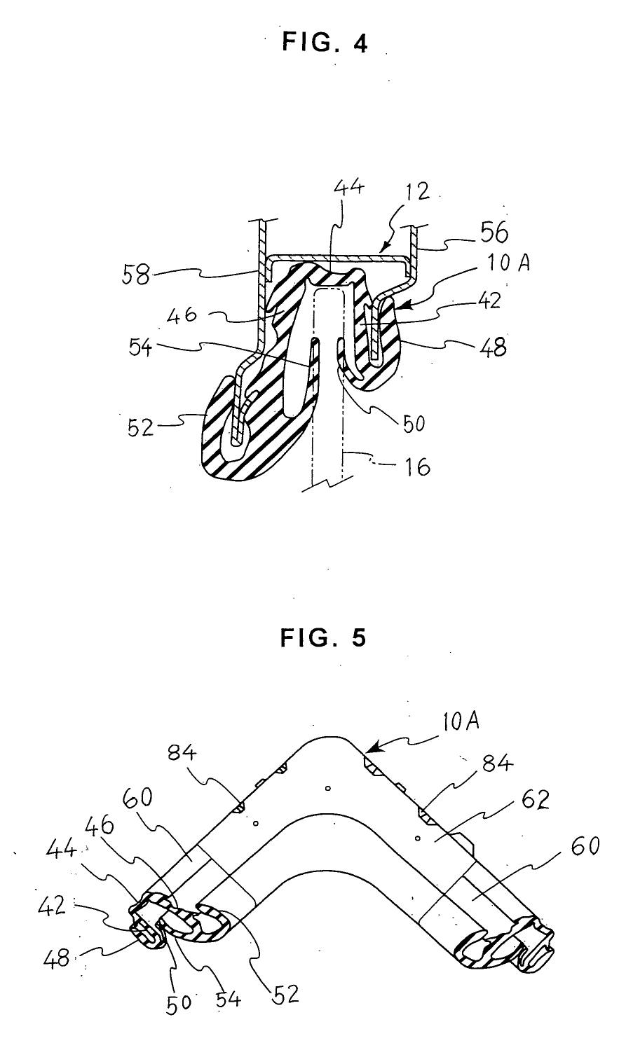

Embodiments of the present invention will be explained with reference to FIGS. 1 and 4 through 8. FIG. 4 is a cross-sectional view of a door glass run 10A. As shown, the door glass run 10A has a generally U-shaped cross-section which is generally identical over the entire length thereof, and includes an outside wall 42, a bottom wall 44 and an inside wall 46 to define a channel. An outside moulding lip 48 and an outside seal lip 50 extend from an end of the outside wall 42, whereas an inside moulding lip 52 and an inside seal lip 54 extend from an end of the inside wall 46. The door glass run 10A thus arranged extends along an inner periphery of the door frame 12 and is attached thereto such that an end edge of an outer panel 56 is fitted between the outside wall 42 and the outside moulding lip 48, whereas an end edge of an inner panel 58 is fitted between the inside wall 46 and the inside moulding lip 52. And the door glass 16 is mounted so as to slide between the outside seal lip 50 and the inside seal lip 54.

As shown in FIG. 5, the door glass run 10A includes straight parts 60 formed by extrusion, and a corner part 62 formed by molding.

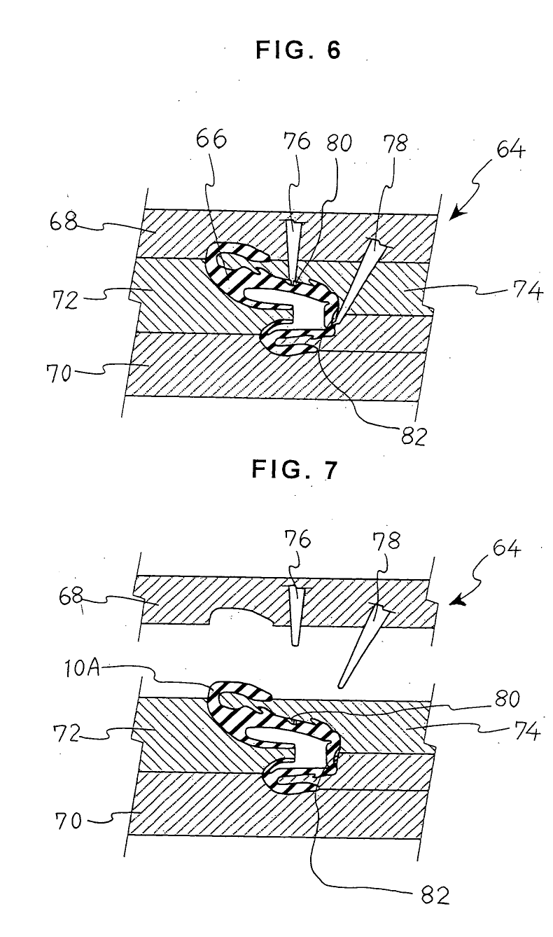

To form the corner part 62 by molding, as shown in FIGS. 6 and 7, ends of the extruded straight parts 60 are placed in a mold 64 so as to face a mold cavity 66, and a molding material is injected into the mold cavity 66 to connect the extruded straight parts 60 with the molded corner part 62.

The mold 64 includes an upper mold 68, a lower mold 70, an inside middle mold 72 and an outside middle mold 74. The inside middle mold 72 and the outside middle mold 74 are respectively fitted between the upper mold 68 and the lower mold 70. The mold 64 which is closed defines the mold cavity 66 having a configuration conforming to that of a desired corner part. The molding material is injected into the mold cavity 66 with a plurality of first sprue gates 76 and a plurality of second sprue gates 78, which are respectively defined by the upper mold 68 and the outside middle mold 74.

The first sprue gates 76 extend from the upper mold 68 in a generally vertical direction through the outside middle mold 74. Each of the first sprue gates 76 has a tapering configuration towards its lower end, and the lower end thereof has a reduced diameter. The outside middle mold 74 has a plurality of protrusions 80, each projecting into the mold cavity 66 from the positions corresponding to the first sprue gates 76. The first sprue gates 76 extend such that the lower ends thereof penetrate the protrusions 80 and open into an upper part of the mold cavity 66, which is adapted to mold the inner side wall 46.

The second sprue gates 78 extend from the upper mold 68 in an oblique direction through the outside middle mold 74. Each of the second sprue gates 78 has a tapering configuration towards its lower end, and the lower end thereof has a reduced diameter. The outside middle mold 74 has a plurality of protrusions 82, each projecting into the mold cavity 66 from the positions corresponding to the second sprue gates 78. The second sprue gates 78 extend such that the lower ends thereof penetrate the protrusions 82 and open into a lower part of the mold cavity 66, which is adapted to mold the bottom wall 44.

With this arrangement, since the second sprue gates 78 extend in an oblique direction, they can be prevented from interfering with the upper part of the mold cavity 66, which is adapted to mold the inside wall 46 of the corner part 62.

The molding material injected with the first sprue gates 76 flows into the upper part of the mold cavity 66, which is adapted to mold the inside wall 46, the inside moulding lip 52 and the inside seal lip 54, to fill the same entirely.

And the molding material injected with the second sprue gates 78 flows into the lower part of the mold cavity 66, which is adapted to mold the bottom wall 44, the outside wall 42, the outside moulding lip 48 and the outside seal lip 50, to fill the same entirely.

Since the molding material is injected into the mold cavity 66 from two positions with the first sprue gates 76 and the second sprue gates 78, the molding material speedily and entirely fills the mold cavity 66 in a short injection time.

The molding material is composed of a synthetic rubber such as EPDM rubber, thermoplastic elastomer such as polyolefin elastomer, or a soft synthetic resin such as soft polyethylene.

In the case of synthetic rubber, it is heated for vulcanization after injected into the mold cavity 66, whereas in the case of thermoplastic elastomer or soft synthetic resin, it is cooled for solidification. As shown in FIG. 7, the mold 64 is opened after vulcanization or solidification of the molding material. The upper mold 68 is first opened upwards. The molding material remaining in the sprue gates 76 and 78 is pulled up with the upper mold 68 so as to be cut off at its end having a reduced diameter. Then, the inside middle mold 72 and the outside middle mold 74 along with the door glass run 10A are removed from the lower mold 70. And, the inside middle mold 72 and the outside middle mold 74 which includes the protrusions 80 and 82 are removed from the door glass run 10A. In a resultant door glass run 10A (FIG. 5), thin projections molded by the lower ends of the sprue gates 76 and 78 remain in the inside wall 46 and the bottom wall 44 of the molded part 62 thereof. But, these thin projections are positioned within resultant depressions 84 in the molded part 62, and do not protrude from outer surfaces thereof. Accordingly, the molded part 62 can be attached to the door frame 12 closely and securely without exhibiting the problems encountered with the conventional producing method.

After removing the molding material remaining in the sprue gates 76 and 78, another molding step is carried out by assembling the inside middle mold 72, the outside middle mold 74 and the lower mold 70, placing ends of another extruded straight parts, and assembling the upper mold 68.

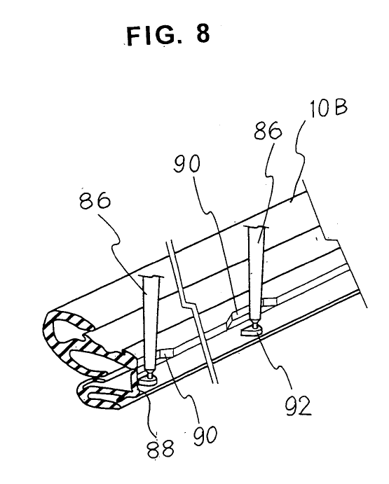

Hereinafter, another example of the arrangement of the second sprue gates will be explained with reference to FIG. 8. The arrangement of the first sprue gates is identical to that shown in FIGS. 5, 6 and 7, and accordingly, explanations thereof will be omitted.

A plurality of second sprue gates 86 are defined by a mold (not shown) which has an upper mold, a lower mold, an inside middle mold and an outside middle mold, similarly to the mold shown in FIG. 6. A plurality of protrusions (not shown) are provided in the outside middle mold so as to protrude into the mold cavity from the positions adapted to mold an upper end of a bottom wall 88 of a door glass run 10B. Each of the second sprue gates 86 extends downwardly from the upper mold through the protrusion of the outside middle mold so that it can extend to the vicinity of a lower part of the mold cavity which is adapted to mold the lower part of the bottom wall 88 of the door glass run 10B in a generally vertical direction.

The lower end of each second sprue gate 86, which has a reduced diameter, is communicated with the lower part of the mold cavity by way of a short tab gate (not shown).

Upon molding a corner part of the door glass run 10B, the molding material is injected into the mold cavity with the first sprue gates and the second sprue gates 86, and after molding, the molding material remaining in the first sprue gates and the second sprue gates 86 is cut off at its lower end having a reduced diameter automatically with the opening of the mold, similarly to the preceding embodiment. Consequently, the molded corner part has depressions 90 in the positions corresponding to the protrusions of the outside middle mold, and also has tabs 92 molded by the short tab gates. But, these tabs 92 are short so as not to protrude outwardly from the depressions 90 in the bottom wall 88 of the door glass run 10B.

With this arrangement, the lower end of each vertically extending second sprue gate 86 can reach the vicinity of the lower part of the mold cavity, which is adapted to mold a bottom wall 88 of the door glass run 10B, without providing any long tab gate. This arrangement can be preferably used in the case where the bottom surface of the bottom wall 88 has a configuration which curves toward an open end of the door glass run.

With this arrangement, the second sprue gates 86 can extend vertically by virtue of the protrusions provided in the outside middle mold, whereby the length of the second sprue gates can be decreased, as compared with the obliquely extending second sprue gates, and the molding material can be injected in the mold cavity at about the same time with the injection with the first sprue gates.

In the embodiments shown in FIGS. 6 through 8.the protrusions provided in the outside middle mold respectively have a semicircular convex configuration or trapezoidal configuration. Alternatively, the configuration of the protrusions can be arbitrarily selected in view of the size, position, etc. of the second sprue gates.

The present invention has been explained based on the door glass run for attachment along the door frame. The present invention is also applicable to weather strips such as door weather strips, opening weather strips, etc.

In summary, in the method for producing a weather strip in accordance with the present invention, the mold for molding a corner part at ends of extruded straight parts has protrusions protruding into a mold cavity from the positions adapted to mold a bottom part of the weather strip, and sprue gates for injecting a molding material into the mold cavity are defined by the mold so as to penetrate the protrusions.

With this method, after cutting the remaining molding material in the sprue gates, resultant projections or tabs do not project greatly from the bottom of the molded corner part. Accordingly, the molded corner part of the weather strip can be attached to the door frame closely and securely. In addition, upon opening the mold, the remaining molding material in the sprue gates can be automatically cut off so as not to require any cutting process, thereby increasing the productivity and decreasing the production costs.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. A method for producing a weather strip which includes an extruded straight part and a molded part provided at an end of the extruded straight part, comprising the steps of:
providing protrusions in a mold so as to protrude into a mold cavity from positions adapted to mold a bottom part of the weather strip;
injecting a molding material from an upper face of said mold into said mold cavity from positions adapted to mold a side part of the weather strip with a plurality of first sprue gates provided on an upper side of said mold,
injecting a molding material from an upper face of said mold into said mold cavity from positions adapted to mold the bottom part and another side part of the weather strip through said protrusions provided in said mold with a plurality of second sprue gates provided on an upper side of said mold; and
opening said mold such that the molding material is cut at joints between said second sprue gates and said mold cavity.

2. A method for producing a door glass run which includes extruded straight parts, each having a generally U-shaped cross-section, and a molded part molded for connecting ends of said extruded straight parts to each other, comprising the steps of:
providing protrusions in a mold so as to protrude into a mold cavity from positions adapted to mold a bottom wall of the door glass run;
injecting a molding material from an upper face of said mold into said mold cavity from positions adapted to mold a side wall of the door glass run with a plurality of first sprue gates provided on an upper side of said mold,
injecting a molding material from an upper face of said mold into said mold cavity from positions adapted to mold the bottom wall and another side wall of the door glass run through said protrusions provided in said mold with a plurality of second sprue gates provided on an upper side of said mold; and
opening said mold such that the molding material is cut at joints between said second sprue gates and said mold cavity.

3. A method for producing a weather strip as claimed in claim 1, wherein the molding material is injected with said second sprue gates directly.

4. A method for producing a weather strip as claimed in claim 1, wherein the molding material is injected with said second sprue gates by way of short tab gates provided in said protrusions.

5. A method for producing a door glass run as claimed in claim 2, wherein the molding material is injected with said second sprue gates directly.

6. A method for producing a door glass run as claimed in claim 2, wherein the molding material is injected with said second sprue gates by way of short tab gates provided in said protrusions.

7. A method for producing a door glass run as claimed in claim 2, wherein said plurality of second sprue gates are provided so as to extend in an oblique direction relative to the opening and closing direction of said mold, and open into said mold cavity directly, and lower ends of said plurality of second sprue gates are located in said protrusions.

8. A method for producing a door glass run as claimed in claim 2, wherein said second sprue gates open into a lower part of said mold cavity, which is adapted to mold a lower part of said bottom wall of said door glass run, said protrusions are provided so as to protrude into an upper part of said mold cavity, which is adapted to mold an upper part of said bottom wall of said door glass run, and said plurality of second sprue gates are provided so as to extend through said protrusions in a generally vertical direction.

9. A method for producing a door glass run as claimed in claim 2, further comprising the steps of providing another protrusions in an upper part of said mold so as to protrude into said mold cavity from positions adapted to mold said one side wall of said door glass run, wherein said plurality of first sprue gates are provided so as to inject the molding material through said another protrusions in a generally vertical direction.
